(19) United States
(12) Patent Application Publication
(10) Pub. No.: US 2012/0174868 A1
(43) Pub. Date: Jul. 12, 2012

(54) FEEDER AND METHOD FOR FEEDING LIVESTOCK

(76) Inventor: Henry Pinand, Rockaway, NJ (US)

(21) Appl. No.: 12/986,444

(22) Filed: Jan. 7, 2011

(51) Int. Cl. A01K 1/10; A01K 5/00

(52) U.S. Cl. 119/60

(57) ABSTRACT

A feeder for horses or other livestock includes a housing having a compartment with an air-permeable floor for subjacently supporting a pile of hay, or other type of livestock feed. The compartment is superiorly accessible for allowing feeding from atop the pile of hay or other type of livestock feed. A blower located downstream of the compartment can draw air downwardly through the compartment. With hay or other type of livestock feed loaded into the feed compartment, the blower can draw air downwardly through the compartment and through the floor. Thus, airborne material from the hay or other type of livestock feed is drawn away from an animal that may be feeding from the top of the compartment.

### BACKGROUND OF THE INVENTION

1. Field of the Invention

The present invention relates to livestock feeders and feeding methods, which may incorporate ventilation equipment and methods.

2. Description of Related Art

Horses and other livestock housed in stables often develop a respiratory disease. In horses this disease is referred to as heaves. Heaves is a form of chronic obstructive pulmonary disease (COPD) apparently caused by environmental factors. Afflicted animals have difficulty breathing, chronic coughing, and an accumulation of mucous. This condition can reduce the animal's capacity to work and can dramatically reduce the performance of race horses.

When horses or other livestock consume hay or other feeds they tend to disturb material in the comestibles, such as dust, particles of vegetation, mold spores, and bacteria. Some of this material will become airborne and if inhaled, can harm the respiratory systems of the animals or people tending the livestock. Moreover, the newly airborne material tends to concentrate at the feeder around the animal's nose, thereby making inhalation of this airborne material highly likely.

One proposal for reducing airborne material is to wet the hay in advance. However, horses tend to shun wet hay. More importantly, wetting the hay may promote the growth of mold and exacerbate the problem.

Proper ventilation in a stable or barn can reduce the volume of airborne material. However, this airborne material will still temporarily concentrate at the place and time of origin, namely, the station where the animal is feeding. Moreover, ventilation systems may cause drafts that can unintentionally kick up dust from various locations. For example, the floor of a horse's stall is often covered with a sawdust bedding that usually contain dust and other particulate matter. Ground drafts across this bedding can launch a significant amount of airborne material. In fact, just cleaning this bedding can generate even more airborne material.

Also, providing proper ventilation to horse stalls can be difficult. Some stalls are not located at an external wall and so complex ductwork would be needed to provide effective ventilation to these central stalls. Even if an exterior wall was nearby, many horse owners rent space in a barn and would not be permitted by the landlord to run ductwork and cut holes in exterior walls.

Refer also to U.S. Pat. Nos. 3,942,479; 4,292,927; 5,134,972; 5,381,759; 5,477,810; 5,509,377; 5,564,364; and 6,341,579; as well as US Patent Application Publication Nos. 2004/0050338; and 2007/0137584.

### SUMMARY OF THE INVENTION

In accordance with the illustrative embodiments demonstrating features and advantages of the present invention, there is provided a livestock feeder having a blower and a housing. The housing has a compartment with an air-permeable floor for subjacently supporting a pile of food. The compartment is superiorly accessible for allowing feeding from atop the pile of food. The blower is located downstream of the compartment for drawing air downwardly through the compartment.

In accordance with another aspect of the invention, a method is provided for feeding livestock. The method employs a blower and a food compartment having an air-permeable floor. The method includes the step of loading food into the food compartment. Another step is using the blower from a position located downstream of the compartment to draw air downwardly through the compartment and through the floor. The method also includes the step of allowing livestock to eat the food from the top of the compartment.

By employing apparatus and methods of the foregoing type, an improved feeding technique is achieved, which reduces the risk of respiratory disease in livestock. As used herein livestock refers to any type of animal, including household pets.

In a disclosed embodiment, a portable, freestanding, self-contained unit has an upper compartment that can be filled with hay or other type of livestock feed.

The disclosed unit has a hinged lid that can be lifted so that hay or other livestock feed can be loaded into the compartment. After closing the lid, a horse or other livestock can feed through a hole in the lid.

In this disclosed embodiment, the hay or other livestock feed rests on a drawer in the bottom of the compartment. The bottom of the drawer is fitted with a coarse screen overlaid with a porous panel, such as window screening or a filter. A blower below the drawer and near the bottom of the disclosed unit can draw air down through the feed compartment and through the bottom of the drawer. In this embodiment a number of filters can be placed between the drawer and the blower to filter fine particles.

The filtered air discharged from the blower reaches the bottom of the disclosed unit and is diverted upwardly into a pair of vertical side chambers. The diverted air travels to the top of the side chambers before being discharged through exhaust vents at the top of the chambers. Being discharged at the top, the exhaust does not produce appreciable ground drafts that might stir up dust and other material in the bedding lying on the ground near the unit.

The disclosed unit is in the form of a cabinet with a door that can be opened to provide access to the drawer at the bottom of the feed compartment, as well as the filters and the blower below the drawer. Accordingly, the drawer can be removed in order to clean or replace the screens or filters therein. Also, the filters under the drawer can likewise be cleaned or replaced. In addition, the blower sits on a sliding tray and can be slid out for servicing.

In one embodiment the unit is in the form of the rectangular cabinet with a central feed compartment flanked on the right and left by two air chambers. Each chamber has a lower inlet to accept filtered air drawn from the feed compartment and an upper exhaust vent to discharge this filtered air. The unit does not require ducts to vent the outside of the building. Thus, installation is simple and does not require cutting holes in the side of a building

In another embodiment, the feed compartment and the space below forms a square prism with a rear pair of its adjacent sides designed to fit snugly in the corner of a stall. The other two outer sides are contiguous with two outer air chambers, each chamber in the form of a triangular prism. The cross sections of the outer chambers are substantially identical, right isosceles triangles whose hypotenuses (inside faces) are coextensive with the two outer sides of the feed compartment. This results in a five-sided cabinet having a wide front face and extending perpendicularly therefrom two shorter side faces. These two side faces extend backwardly to intersect at 135° two rear faces that in turn converge and meet at a right angle. The inside face of each outer air chamber has a lower inlet to accept filtered air drawn from the feed chamber. One of the outside faces of each outer chamber has an upper exhaust vent to discharge this filtered air. In this embodiment, one of the air chambers is an separate unit that is hinged and can swing away to allow access to the internal drawer and filters.

In a disclosed embodiment a proximity sensor mounted near the top of the feed compartment can sense the presence of a feeding animal. The blower is started upon detection of the presence of the animal. Consequently any material that might become airborne is immediately drawn downwardly into the pile of feed. A downward draft is advantageous because gravity cooperates with the downward migration of the airborne material.

Typically, feeding livestock will pause and withdraw from the feed compartment. However, stopping the blower for this brief withdrawal would be counterproductive and would allow airborne material to diffuse upwardly, placing the returning animal at risk. For this reason, the proximity sensor cooperates with a timer that, in the temporary absence of the animal, will keep the blower running long enough to ensure that the animal has finished feeding.

### BRIEF DESCRIPTION OF THE DRAWINGS

The above brief description as well as other objects, features and advantages of the present invention will be more fully appreciated by reference to the following detailed description of illustrative embodiments in accordance with the present invention when taken in conjunction with the accompanying drawings, wherein:

FIG. 1 is perspective view a livestock feeder in accordance with principles of the present invention;

FIG. 2 is a perspective view of the feeder of FIG. 1, shown open for servicing and loading;

FIG. 3 a top view of the feeder of FIG. 1;

FIG. 4 is a top view of the feeder of FIG. 3 with the lid removed;

FIG. 5 is a top view according to FIG. 4 but with one of its side chambers swung outwardly;

FIG. 6 is a horizontal sectional view taken near and facing the bottom of the feeder of FIG. 1 (taken along line 6-6 of FIG. 9), and with the overhead position of two of the internal walls of the feed compartment shown by dotted lines;

FIG. 7 is an elevational view of the feeder of FIG. 2 taken normal to the exposed ends of the drawer frame and filters;

FIG. 8 is a vertical sectional view of the left end of the drawer frame of FIG. 8;

FIG. 9 is a vertical sectional view taken along line 9-9 of FIG. 4;

FIG. 10 is a schematic diagram of the proximity sensor, timer and blower of FIGS. 2 and 8;

FIG. 11 is a perspective view of a livestock feeder that is an alternate to that of FIGS. 1-9; and

FIG. 12 is a vertical sectional view that bisects the feeder and is parallel to the front of the feeder.

### DETAILED DESCRIPTION OF THE PREFERRED EMBODIMENTS

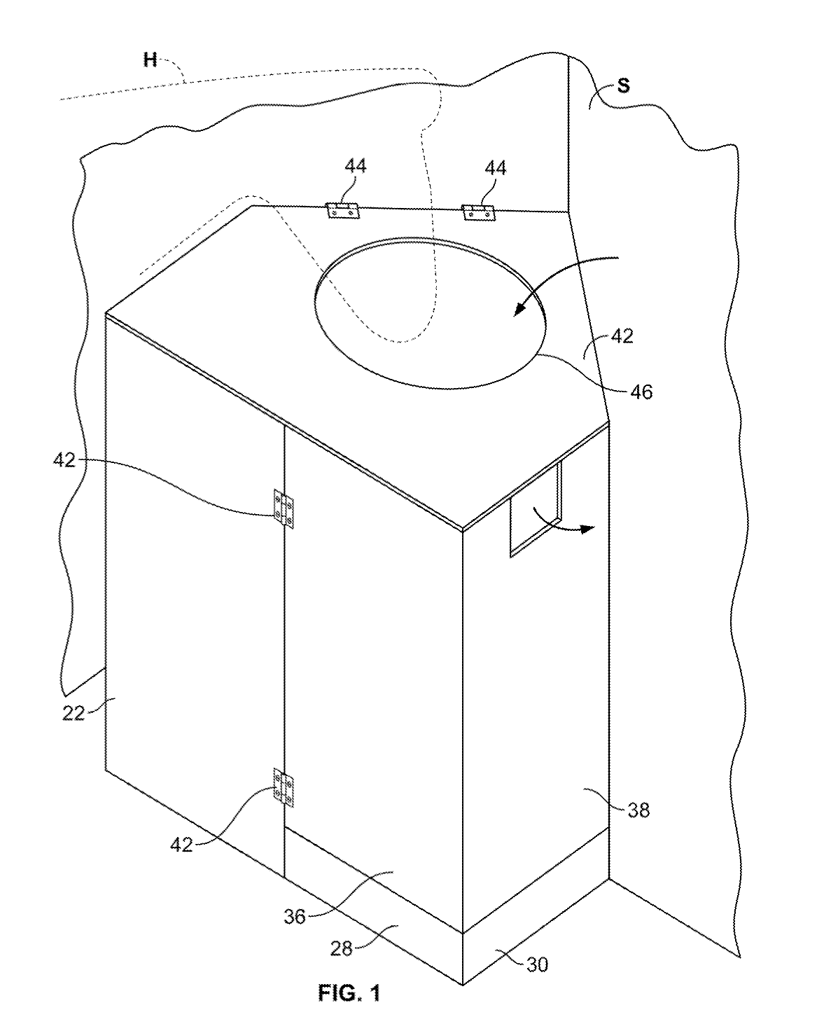

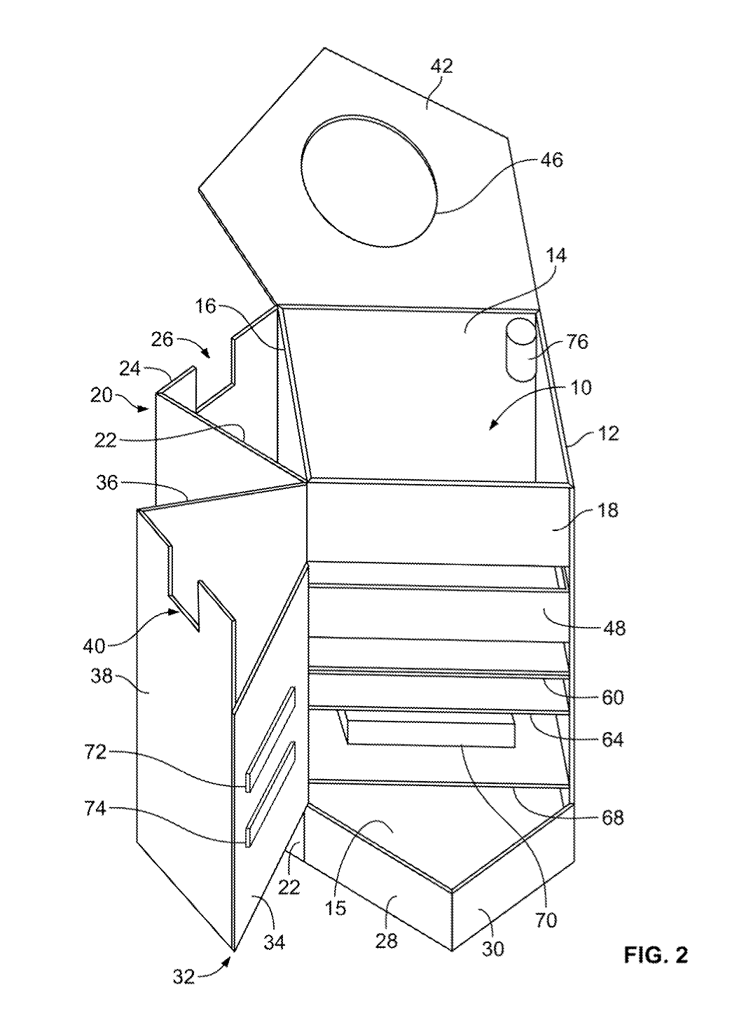

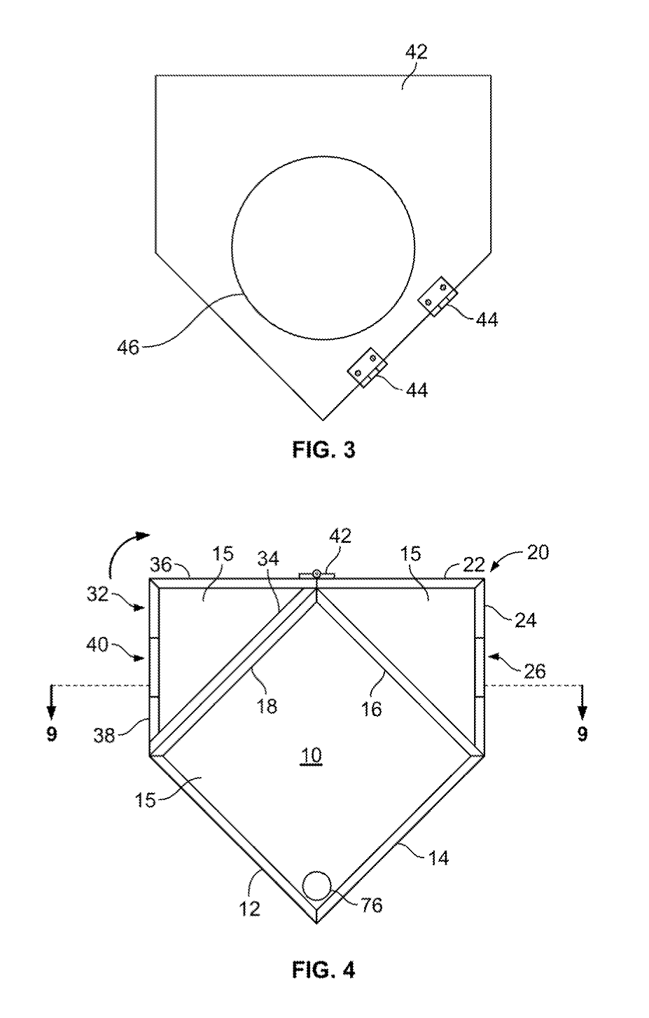

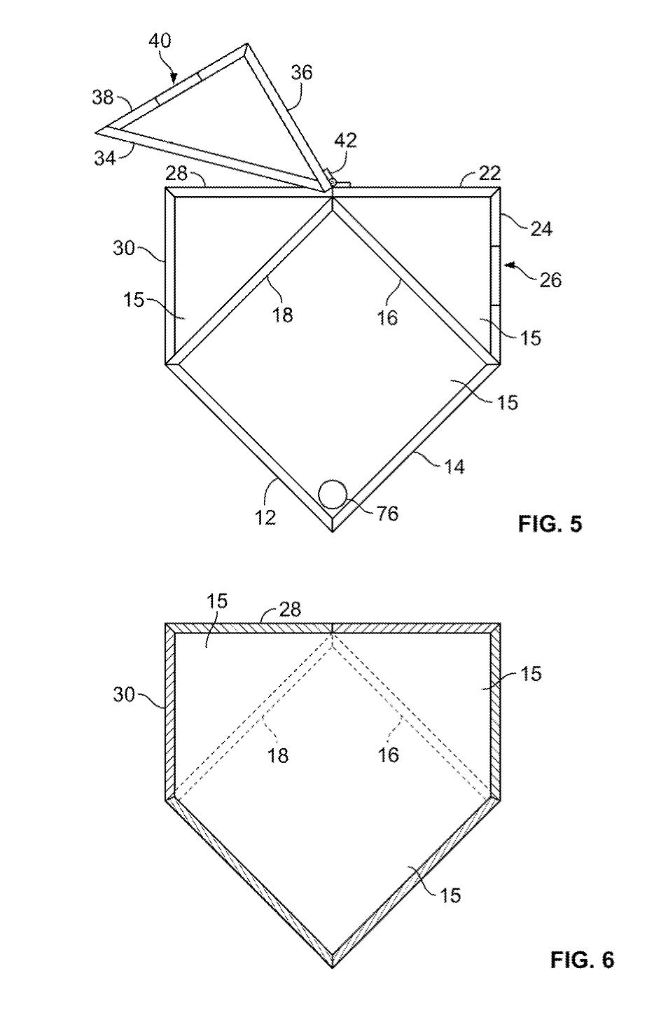

Referring to FIGS. 1-6, the illustrated livestock feeder is a housing having a four-sided compartment 10. Compartment 10 is shown in FIG. 2 with a square opening. The two rear sides of compartment 10 are bounded by vertical rectangular panels 12 and 14, which form a 90° corner and are attached on the bottom to two rear edges of floor 15. The front left side of compartment 10 is bounded by vertical rectangular panel 16 which descends from the rim of compartment 10, about 90% of the way to floor 15, thus leaving a lower gap to allow airflow under the panel. The right front side of compartment 10 is partially bounded by vertical rectangular panel 18, which extends from the rim of compartment 10 about one third of the way toward floor 15. Panels 12, 14, 16 and 18 are attached together on their vertical edges.

Vertical rectangular panel 22 extends from the right edge of rectangular panel 16 at 45°. Panel 24 extends from the left edge of panel 16 at 45° and joins to the distal edge of panel 22 at a right angle. Panel 24 attaches at the bottom to the left edge of floor 15. Panel 22 attaches at the bottom to the left half of the front edge of floor 15. The right half of this front edge is bordered by vertical apron 28, which joins at a right angle to vertical apron 30 mounted on the right edge of floor 15. Aprons 28 and 30 are about 10% of the overall height of the feeder.

A rectangular notch 26 along the top edge of panel 24 operates as a superiorly located exhaust vent. Panels 16, 22 and 24 function as a three-sided, side chamber 20.

Another similar, three-sided, side chamber 32 is formed with panels 34, 36 and 38. Panels 36 and 38 join at a right angle and intersect panel 34 at 45°. Panel 34 is about ⅓ shorter than panels 36 and 38. This chamber 32 is open on top and bottom. The upper edge of panel 38 has a rectangular notch 40, herein referred to as a superiorly located exhaust vent.

Panel 36 is pivotally attached to panel 22 by means of a pair of hinges 42. Accordingly, chamber 32 can swing from the open position shown in FIG. 2 to the closed position shown in FIG. 1. In doing so panel 34 acts like a door and slips under panel 18 to effectively close the side of chamber 10 and most of the volume underneath it. Also, when closed, panels 36 and 38 align with aprons 28 and 30, respectively.

Lid 42 is pivotally attached by means of hinges 44 to panel 14. When chamber 32 is in the closed position, lid 42 can be swung down to cover that chamber, chamber 20 and compartment 10. Lid 42 has a hole 46 large enough to allow livestock to gain access to compartment 10.

When closed as shown in FIG. 1, the illustrated housing is configured as a compact, five-sided cabinet that can fit into the corner of a stall S. In the illustrated embodiment this cabinet is 32 inches (81 cm) tall and is designed for feeding a horse. Compartment 10 is a 20 inch (51 cm) square compartment and has a 17 inch (43 cm) vertical depth (the depth includes the depth of drawer frame 48). It will be appreciated that these dimensions can change depending upon the intended livestock, the desired capacity, available space, etc.

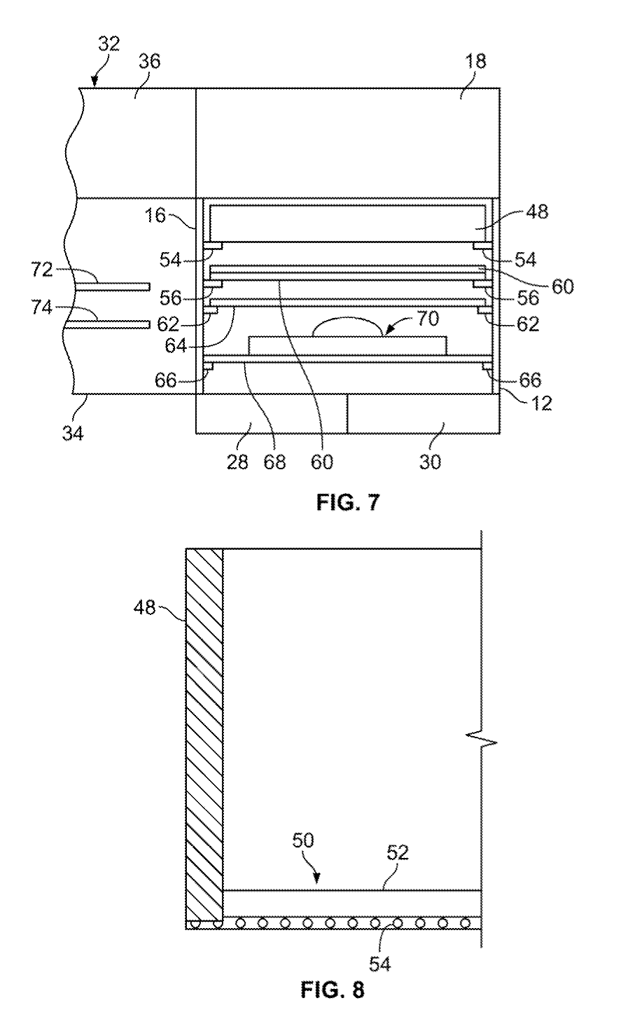

Referring to FIGS. 7 and 8, the previously mentioned compartment (compartment 10 of FIG. 2) is closed on the bottom by a four-sided drawer frame 48. Frame 48 has an air-permeable floor 50 in the form of a screen 52 supported on a coarse screen 54 that is secured to the underside of frame 48. Screen 54 may be a half inch (13 mm) mesh. Screen 52 may be a porous panel and in one embodiment the filter was a window screen in a plastic frame. Drawer frame 48 can slide on a pair of parallel runners 54 mounted on panels 12 and 16.

Mounted below runners 54, again on panels 12 and 16, are another parallel pair of runners 56 for slidably supporting a stack of two filters 60. Mounted below runners 56, once again on panels 12 and 16, are another parallel pair of runners 62 for slidably supporting filter 64.

Mounted below runners 62, again on panels 12 and 16, are another parallel pair of runners 66 for supporting sliding tray 68. Mounted over a hole (not shown) in tray 68 is a blower 70 in the form of an open frame supporting a motor-driven fan blade for pulling air downwardly. Tray 68 may have an electrical outlet box (not shown) to accept a plug on a power cord (not shown) from blower 70. In one embodiment blower 70 had a rating of 1500 ft³ /min (42 m³/min), although different ratings can be employed depending on the type of livestock, the required filtering, the desired capacity, etc.

Rail 72 on panel 34 is designed to fit under runners 56 when chamber 32 is closed and panel 34 moves under panel 18. Rail 72 restricts air from bypassing filters 60. Likewise, rail 74 on panel 34 will fit under runners 62 to restrict air from bypassing filter 64.

Referring to FIG. 10, device 76 and previously mentioned blower 70 are connected in series across power plug 78, which is designed to plug into an ordinary electrical outlet. Device 76 includes proximity sensor 76A, which may use ultrasonic, infrared or other types of sensors to detect the presence of an animal feeding at the compartment (compartment 10 of FIG. 2). When sensor 76A first detects the presence of the animal, it causes timer 76B to complete the circuit from power plug 78 through blower 70. Should the animal leave the vicinity, timer 76B will maintain power to blower 74 for a predetermined time interval, for example, at least five minutes. Thus blower 70 will remain powered even though the animal may temporarily withdraw from the feeder.

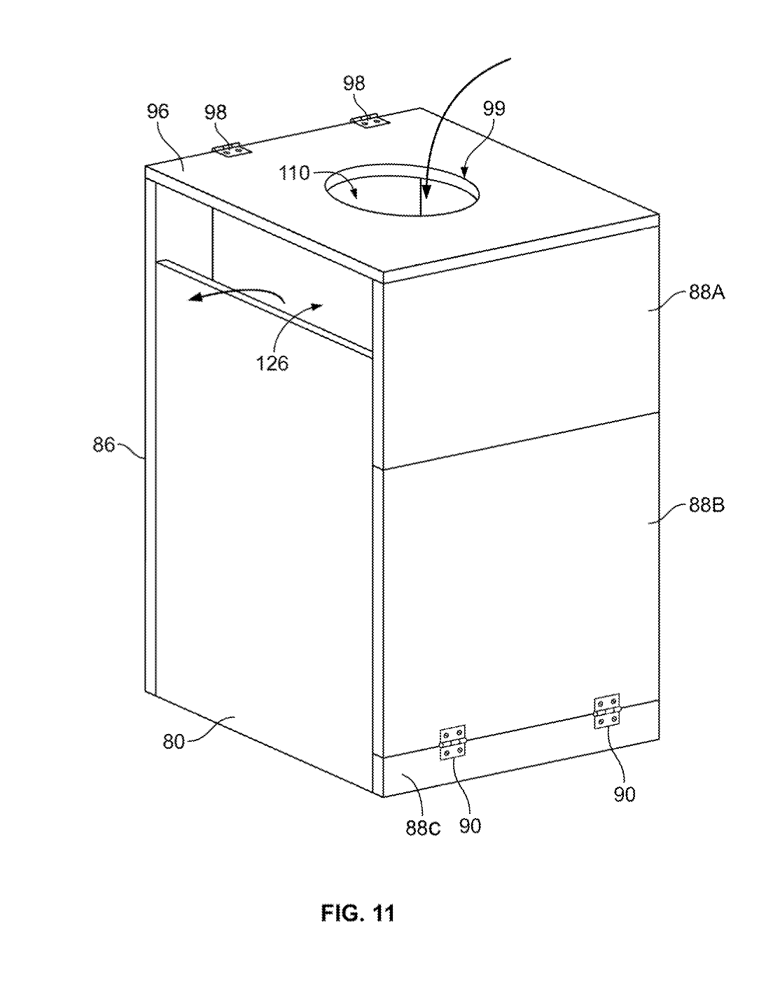

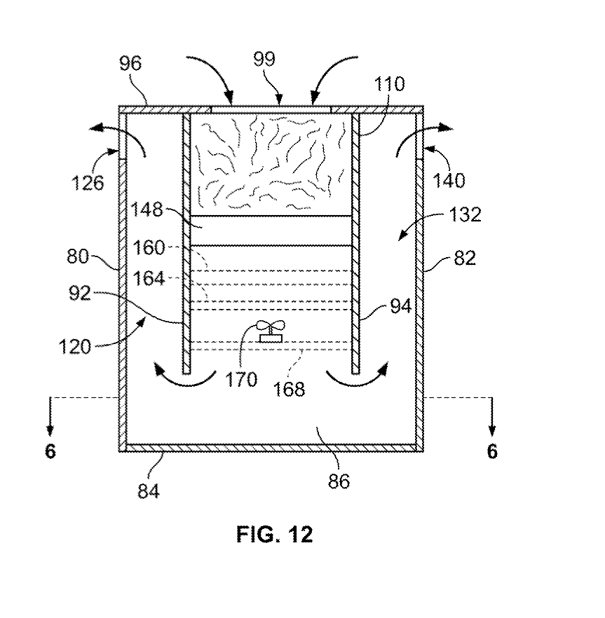

Referring to FIGS. 11 and 12, components in the illustrated feeder corresponding to those in the embodiment of FIG. 1-9, bear the same reference numeral but increased by 100. The illustrated feeder is a housing in the form of a cabinet having rear panel 86 and side panels 80 and 82, all attached at right angles to rectangular floor 84. Internal baffles 92 and 94 are attached perpendicularly to the inside face of rear panel 86, parallel to panels 80 and 82 and spaced from them and floor 84. The front of the feeder is formed of panels 88A, 88B and 88C. Upper panels 88A and lower panel 88C are secured to the front edges of panels 80, 82, 92 and 94. Door panel 888 is shown positioned between panels 88A and 88C and is pivotally attached to the upper edge of lower panel 88C by means of hinges 90.

Pivotally connected to rear panel 86 by means of hinges 98 is rectangular lid 96 with a circular hole 99. When lid 96 is in the closed position as shown, lid 96 rests atop baffles 92 and 94 and the upper edge of panel 88A.

Because baffles 92 and 94 do not reach floor 84, air descending between the baffles can flow under them and up into chamber 120 between panels 80 and 92 and into chamber 132 between panels 82 and 94. Panels 80 and 82 fall short of lid 96 and therefore allow air to pass over them and out through exhaust vents 126 and 140, respectively.

The upper space between panels 86, 88A, 92 and 94 form a compartment 110 similar to the previously mentioned compartment (compartment 10 of FIG. 1). As before, the bottom of compartment 110 is fitted with a sliding drawer frame 148 having the same air permeable floor as described previously. Again as before, filters 160 and 164 are slidably mounted between baffles 92 and 94. Also as before, blower 170 is mounted on a sliding tray 186 between baffles 92 and 94.

Rear panel 86 is designed to sit flush against a wall with clearance around panels 80 and 82 to allow free flow of the exhaust through vents 126 and 140.

To facilitate an understanding of the principles associated with the foregoing apparatus, its operation will be briefly described in connection with the embodiment of FIGS. 1-10. It will be appreciated that the embodiment of FIGS. 11-12 operates in a similar fashion.

The feeder of FIGS. 1-10 can be easily transported to any horse stall without regard to whether the stall is near an exterior wall. Installation simply requires positioning the feeder in the stall and supplying electrical power from a nearby outlet or otherwise. This simple installation will not raise objections from a facility owner in instances where the horse is being boarded

Starting with the feeder open as shown in FIG. 2, a user may swing chamber 32 into the closed position with panel 34 slipping under panel 18. Chamber 32 may be held closed with an appropriate latch (not shown).

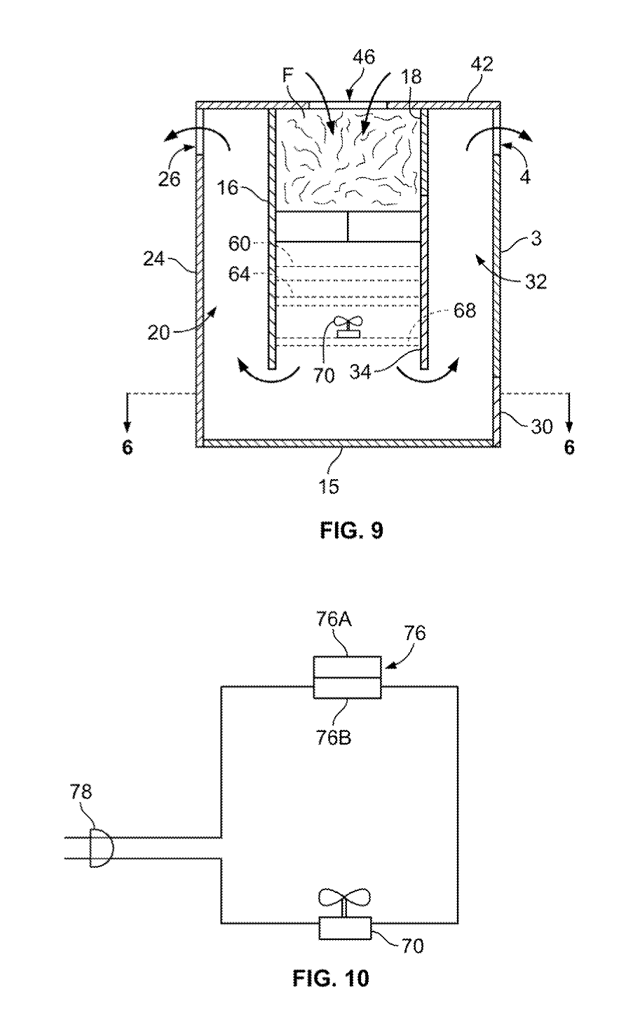

A user may then load a pile of hay F (FIG. 9) down into compartment 10 to rest on floor 50 of drawer frame 48. In some cases hay F may be instead grain, processed feed or any other type of comestibles consumed by a horse or other animal. The hay (or other livestock feed) F may be loose or in the case of horses, may be slabs (flakes) of hay that are stacked inside compartment 10. The hay or other comestibles F need not be wetted to suppress airborne particles and so horses or other livestock will not be repelled by any wetness or mold growth promoted by wetness. Thereafter, lid 42 may be closed to bring the feeder into the condition shown in FIG. 1.

Horse H is shown in FIG. 1 inserting its mouth through hole 46 to consume feed F (FIG. 9). Proximity sensor 76A of device 76 (FIG. 10) detects the animal's presence and operates timer 76B to close a circuit and start blower 70. Consequently, air is drawn down through hole 46 in lid 42 as shown in FIG. 9 to pass through the pile of hay or other livestock feed F. A downdraft is advantageous because gravity will assist the removal of airborne material that might harm the feeding animal.

Screen 52 prevents large particles from passing through air permeable floor 50. Air from compartment 10 is sucked downwardly through filter stack 60 to remove some of the finer particles not captured by screen 52. Thereafter, air is drawn through filter 64 to remove some of the finest particles, before being drawn into the intake of blower 70 and discharged towards the bottom 15 of the feeder.

Air is then diverted into two separate paths to flow upwardly in chambers 20 and 32 before being discharged through exhaust vents 26 and 40, respectively.

Horse H will pull on the hay or other livestock feed F when consuming it. With hay the pulling disturbs it and tends to dislodge particles that can easily become airborne. However these airborne particles will be drawn downwardly by blower 72 to reduce the chance of horse H inhaling these particles. Moreover, these airborne particles will, for the most part, be captured by filters 52, 60, and 64.

In addition, air from blower 70 will be discharged at a relatively elevated position through vents 26 and 40. Consequently, this discharged air will not produce substantial ground drafts that would tend to stir up dust from the sawdust bedding located on the floor around the feeder. In addition, the feeder is designed so that hay or other livestock feed F will not tend to fall on the ground where it can become soiled.

Also, blower 70 will not be turned off prematurely when horse H temporarily withdraws its mouth from hole 46. Rather than allow airborne particles to drift out of hole 46, timer 768 will sustain the downdraft by keeping blower 70 energized for a predetermined delay, for example, at least five minutes; although the delay interval can be different depending upon the livestock and the user's preferences. However, if the feeding livestock does not return within the delay interval, timer 76B will shut off blower 70, thereby conserving energy.

All of this is accomplished with a portable, stand-alone unit that does not require complex ductwork for carrying discharged air outside a building. Thus a horse owner can easily bring the unit to any horse stall and use the unit without objection from the owner of horse boarding facility. Also, this unit can be easily serviced by swinging chamber 32 open to expose drawer frame 48, filters 60 and 64, as well as the tray 68 supporting blower 73. Filter 60 and 64 can be slid out and easily cleaned. The filters can be taken outside and shaken to remove the dust or if necessary, replaced. Likewise, drawer frame 48 can be slid out in order to clean or replace screen 52. In addition, tray 68 can be slid out to service blower 70.

It will be appreciated that the feeder of FIGS. 11 and 12 operates in a similar manner. In particular, blower 170 can suck air down through hole 99 in lid 96 to draw airborne particles downwardly through the pile of hay or other livestock feed and through the screen in the floor of drawer frame 148. Drawer frame 148 is identical to the previously mentioned frame (frame 48 of FIG. 8) and has the same air permeable floor.

As before, particles can be further filtered by filters 160 and 164. Air from blower 170 is diverted upwardly through side chambers 120 and 132 before being discharged through superiorly located, exhaust vents 126 and 140, respectively.

As before, lid 96 can be swung open to reload hay or other types of feed into the unit. In addition, door 88B can be swung open for servicing blower 170 on sliding tray 168 and for servicing filters 160 and 164, as well as the screen at the floor of drawer frame 148.

It is appreciated that various modifications may be implemented with respect to the above described embodiments. In some embodiments the feeder may have a different number of filters, including no filters. Filters can be placed either in the downwardly flowing airstream or in the upwardly flowing airstream, but with the blower normally located downstream of all the filters. The disclosed feeder is shown with two chambers for conducting an upwardly airflow but a different number of chambers may be employed in other embodiments. In some embodiments the exhaust may be conducted through a duct to a vent on the outside of the building. The feeder may be enlarged to accommodate more than one animal, either by having multiple feeding compartments or one large feeding compartment. In some cases the feeder will be designed to be wall mounted or mounted on a shelf and the exhaust will be routed appropriately to accommodate such a configuration. Instead of a side chamber some embodiments will employ a duct or stack that will route exhaust upwardly. The feeder can accommodate a variety of livestock including cattle, sheep, goats, fowl, household pets, etc. The various panels of the feeder can be made of wood, composite materials, sheet metal, plastic, etc.

Obviously, many modifications and variations of the present invention are possible in light of the above teachings. It is therefore to be understood that within the scope of the appended claims, the invention may be practiced otherwise than as specifically described.

1. A livestock feeder comprising:
a housing having a compartment with an air-permeable floor for subjacently supporting a pile of food, said compartment being superiorly accessible for allowing feeding from atop said pile of food; and
a blower located downstream of said compartment for drawing air downwardly through said compartment.

2. A livestock feeder according to claim 1 wherein said blower is mounted in said housing under said compartment for drawing air downwardly therethrough.

3. A livestock feeder according to claim 1 comprising:
a filter mounted in said housing between said floor and said blower.

4. A livestock feeder according to claim 3 wherein said compartment includes a drawer frame encompassing and supporting said air permeable floor, said housing comprising:
a door for allowing access to said filter and said drawer frame.

5. A livestock feeder according to claim 4 wherein said floor comprises:
a screen overlaid with a porous panel.

6. A livestock feeder according to claim 3 comprising:
a proximity sensor located at said compartment for operating said blower in order to produce an airflow when the feeder is in use.

7. A livestock feeder according to claim 6 comprising:
a timer coupled to said proximity sensor for delaying stopping of said blower when livestock moves away from said compartment.

8. A livestock feeder according to claim 3 wherein said housing has an exhaust vent for discharging air drawn through said blower.

9. A livestock feeder according to claim 8 wherein said exhaust vent is superiorly located to reduce ground drafts.

10. A livestock feeder according to claim 9 wherein said housing has a side chamber for feeding air drawn from said compartment upwardly to said exhaust vent.

11. A livestock feeder according to claim 9 wherein said housing has a lid with a hole for allowing livestock access to said compartment, said lid can be displaced for filling said compartment with feed.

12. A livestock feeder according to claim 9 wherein said housing includes:
a door for allowing access to and servicing of said filter.

13. A livestock feeder according to claim 12 comprising:
a sliding tray supporting said blower, said door providing access to said blower and permitting removal of said tray and said blower.

14. A livestock feeder according to claim 3 wherein said housing has a pair of superiorly located exhaust vents for discharging air drawn through said blower, said housing having a pair of side chambers for feeding air drawn from said compartment upwardly to different corresponding ones of pair of said exhaust vents.

15. A livestock feeder according to claim 14 wherein said housing is five sided, said compartment being four-sided with two adjacent sides being contiguous with different corresponding ones of said pair of side chambers, said side chambers being three-sided.

16. A livestock feeder according to claim 15 wherein one of said side chambers is hinged to swing outwardly and allow access to said filter and said blower.

17. A livestock feeder according to claim 1 wherein said housing has a lid with a hole for allowing livestock access to said compartment, said lid can be displaced for filling said compartment with food.

18. A method for feeding livestock with a blower and a food compartment having an air-permeable floor, the method comprising the steps of:
loading food into said food compartment;
using said blower from a position located downstream of said compartment to draw air downwardly through said compartment and through said floor; and
allowing livestock to eat the food from the top of the compartment.

19. A method according to claim 18 comprising the step of:
filtering air flowing between said compartment and said blower.

20. A method according to claim 19 comprising the step of:
diverting air from said compartment upwardly to exhaust from an upper location in order to reduce ground drafts.

21. A method according to claim 20 wherein said compartment has a lid with an access hole, the method comprising the step of:
displacing said lid for filling said compartment with food.

22. A method according to claim 20 wherein said blower is mounted on a sliding tray, the method comprising the step of:
removing the blower by outwardly sliding the tray.

23. A method according to claim 20 comprising the step of:
starting said blower when livestock approaches said compartment.

24. A method according to claim 23 comprising the step of:
stopping said blower after a predetermined delay following departure of livestock from said compartment.

25. A method according to claim 18 wherein the step of loading food is performed by loading hay into the food compartment.
